(19) United States
(12) Patent Application Publication
(10) Pub. No.: US 2005/0106290 A1
(43) Pub. Date: May 19, 2005

(54) Serially accessible candy pieces

(76) Inventors: Sidney Diamond, Barrington Hills, IL (US); David P. Lisowski, Schaumburg, IL (US)

Correspondence Address: John S. Pacocha;GREENBERG TRAURIG, P.C., Suite 2500, 77 West Wacker Drive, Chicago, IL, 60601-1732, US

(21) Appl. No.: 10/715,083

(22) Filed: Nov. 17, 2003

(51) Int. Cl. A23G 1/00

(52) U.S. Cl. 426/103

(57) ABSTRACT

A novelty confectionary device with a tubular casing having an upper end and a lower end. Carried in the casing are a number of stacked, individually consumable candy modules, each including a piece of candy mounted on a base. The candy of the uppermost module extends through the top of the tube for consumption. After the candy is consumed, the base is removed, and is then reinserted through the bottom of the tube to advance the candy of the next module through the top of the tube. The base, which may include an anchoring post for the candy, is of a size and configuration such that it does not fit entirely into a standard choke tube gauge for children under the age of three. A clear plastic cap fits over the candy for minimizing contamination prior to consumption.

### BACKGROUND OF THE INVENTION

1. Field of the Invention

This invention relates generally to confectioneries and confectionary devices, and more particularly to novelty confectionary devices of the hard candy lollipop or sucker variety.

2. Background Art

Confectionaries, particularly hard candies such as lollipops or suckers, have long been popular with both children and adults. Manufacturers of such candies must package the candy in a suitable device or dispenser for consumption, that provides for consumption of the candy in a clean, sanitary, and otherwise safe manner. In addition, it is desirable to also provide a novel and entertaining presentation, and manner of consuming of the candy product, especially for children. A novelty candy device that emulates use of a generally perceived adult device, such as lipstick, may prove to be desirable for use by children. For adults, a device that evokes a nostalgic recollection of a confectionary treat of their childhood, such as a push up frozen ice confectionary, may be desirable. There are prior art novelty confectionary devices in which a piece of candy is pushed up out of a cylindrical casing or container for consumption.

Coleman et al. U.S. Pat. No. 5,531,318 issued Jul. 2, 1996 discloses a single, generally cylindrical piece of candy held within a short cylindrical base. The candy and the base are then housed within another cylindrical body which has a spring biased, split cap covering its upper end. The cylindrical base or holder is elongated and its lower portion serves as a handle for pushing the candy up through the split cap for consumption, and then withdrawing it back through the open split cap into the main body for storage. There is, however, no teaching or suggestion that a series of shorter candy pieces could be serially stacked in the main body. Indeed, the elongated holder handle would preclude more than one piece of candy being stacked in the main body.

Coleman et al. U.S. Pat. No. 6,319,085 issued Nov. 20, 2001 also discloses a cylindrical piece of candy that is mounted on a base support that is secured to a push rod for moving the candy out of, and back into, the lower cylindrical portion of a simulated rocket ship. There is a showing of mounting a second piece of candy on the outer end of the push rod so that there would be two pieces of candy for consumption. It also indicates in Column 2, lines 27-28, that the second piece of candy should be covered for sanitary purposes. However, there is still no suggestion of stacking a series of smaller pieces of candy and using the base support of the consumed piece of candy to move the other pieces of candy in the holder to expose the uppermost one for consumption.

Muller-Scherak U.S. Pat. No. 3,809,287 issued May 7, 1974 shows an apparatus for dispensing its individual items in which an item is inserted at the upper end causing the lower most one of a stack of similar items to drop down into a dispensing opening.

Sanchez U.S. Pat. No. 5,951,184 issued Sep. 14, 1999 discloses a combination candy holder writing instrument in which a series of candy pieces are contained within a hollow cylinder. However, there is nothing in anyway teaching or suggesting that any of the candy pieces would be used to advance the dispensing of any of the other candy pieces.

Boyer U.S. Pat. No. 4,415,092 issued Nov. 15, 1983 shows a series of cylindrical holders for generally cylindrical articles in which a single one of the articles is held within an individual cylindrical chamber, and may be dispensed from the chamber by pushing another of the articles into the chamber. While this patent indicates that the holder may be used for a variety of articles such as crayons, bullets, pencils, hair rollers, etc. there is no mention, or any suggestion, that it could be used in connection with candy, or anything else edible. Moreover, it clearly only discloses each individual cylindrical chamber housing a single one of the articles.

There are some stationery products in which an expended eraser or pen point may be reinserted in the bottom of a tubular casing to expose a new eraser or pen point at the top, namely:
Lisa Frank Eraser Pops erasers;
an eraser made by Bensia in Thailand, marked with U.S. Pat. No. 5,345,652 and U.S. Design 355,442; and
a push-up replacement point coloring pen made by Bensai Creative Products in Taiwan.

Chuang U.S. Pat. No. 5,345,652 issued Sep. 13, 1994 and Chuang U.S. Design Pat. Des. No. 355,442 issued Feb. 14, 1995, marked on the Bensia refill eraser, as well as each of the prior art products, disclose a consumable, although not a comestible product, such as candy, which would be desirable to consume in its entirety for a variety of reasons. However, as is clearly indicated, a significant portion of the eraser is enclosed within the holding barrel, and hence that portion of the eraser cannot be used or consumed. Moreover, the post in the lower portion of the holding barrel is shorter than the barrel itself. Thus, neither the holding barrel itself, nor the post, in anyway help to prevent, what remains after the exposed portion of the eraser is used or consumed, from presenting a choking hazard to younger children.

### SUMMARY OF THE INVENTION

The present invention is concerned with providing a novelty confectionary device presenting a plurality of individually consumable pieces of candy in a novel and entertaining manner, which a child may readily, and safely use. The novelty confectionary device comprises a casing having an upper end and a lower end, an opening having a pre-selected size and configuration in the upper end the opening in the upper end, an opening having a pre-determined size and configuration in the lower end, the pre-selected size and configuration fitting into, and passing through the opening of the pre-determined size and configuration, the casing having an opening of the pre-determined size and configuration extending from the opening in the lower end to the opening in the upper end, a plurality of individually consumable candy modules carried in the casing, each of the hard candy modules including a base, the base having an outer periphery generally fitting into, and passing through the opening of the pre-determined size and configuration of the lower end, and the casing, the base being of a fixed overall size and configuration not fitting entirely into a standard choke gauge, the base having an upper section and a lower section with each of the candy modules including an entirely consumable candy piece mounted on the upper section of a respective base, and the candy portion having an outer periphery generally fitting into, and passing through the opening of the pre-selected size and configuration of the upper end for consumption.

To further provide a clean, sanitary novelty confectionary device, a removable, clear plastic cap that fits over the candy for minimizing contamination prior to consumption may be provided.

### BRIEF DESCRIPTION OF THE DRAWINGS

For a better understanding of the present invention, reference may be had to the accompanying drawings in which:

FIG. 1 is a perspective view of an embodiment of the novelty confectionary device;

FIG. 2 is a perspective view of the novelty confectionary device similar to FIG. 1, but with the outer protective cap and wrapper removed;

FIG. 3 is an exploded perspective view of the novelty confectionary device illustrating the removal of one of the individual candy modules;

FIG. 4 is an exploded candy modules;

FIG. 5 is a perspective view of a base of one of the individual candy modules of the novelty confectionary device;

FIG. 6 is a side elevation of the base of one of the individual candy modules of the novelty confectionary device shown in FIG. 5;

FIG. 7 is a top plan view of the base of one of the individual candy modules of the novelty confectionary device shown in FIG. 5;

FIG. 8 is a generally vertical cross-sectional view of a Choke Tester, or Small Objects Tester, with the base of one of the individual candy modules of the novelty confectionary device shown in FIG. 5 inserted;

FIG. 9 is a vertical cross-sectional view of the casing of the novelty confectionary device shown in FIG. 1, taken generally along line 9-9 in FIG. 10;

FIG. 10 is a top plan view of the casing of the novelty confectionary device shown in FIG. 1; and

FIG. 11 is a side elevation of an alternate embodiment of the base of one of the individual candy modules of the novelty confectionary device shown in FIG. 1.

### DETAILED DESCRIPTION

Referring now to the drawings in which like parts are designated by like reference numerals throughout the several views, there is shown in FIG. 1 a novelty confectionary device 20 having a casing 22, which is conveniently formed of an opaque, translucent, or transparent molded, or extruded plastic, as a tube. However, casing 22 may be of any convenient, generally elongated shape having an upper end 24 and a lower end 26. An opening 30 of a pre-determined sized and configuration extends through the casing from the bottom 26 to the top 24. At the bottom of the casing 22 is an opening 32 that is generally of the same pre-determined size and configuration as the opening extending through casing 22. At the upper end 24, there is an opening 34 of a pre-selected size and configuration, which may be the same as the pre-determined size and configuration of openings 30 and 32. However, as a variation, the pre-selected size and configuration of opening 34 may be somewhat smaller than the pre-determined size and configuration of openings 30 and 32, as will be further discussed below. As illustrated in the drawings, each of the casing, base and openings are shown as generally cylindrical such that their configuration is circular; however, they could as well conveniently be of a triangular, square, pentagonal, hexagonal, octagonal, or other polygonal configuration.

Carried within casing 22 are a plurality of candy modules 40. As illustrated in the drawings, there are three candy modules 40, although there could, in accordance with the present invention, be as few as two and the maximum number of such candy modules is virtually unlimited. Each of candy modules 40, as illustrated in the accompanying drawings are virtually identical. There may of course be slight differences resulting from manufacturing tolerances. In addition, though not readily capable of being illustrated in the drawings, it may well be desirable to make the various candy modules 40 of different colors and flavors.

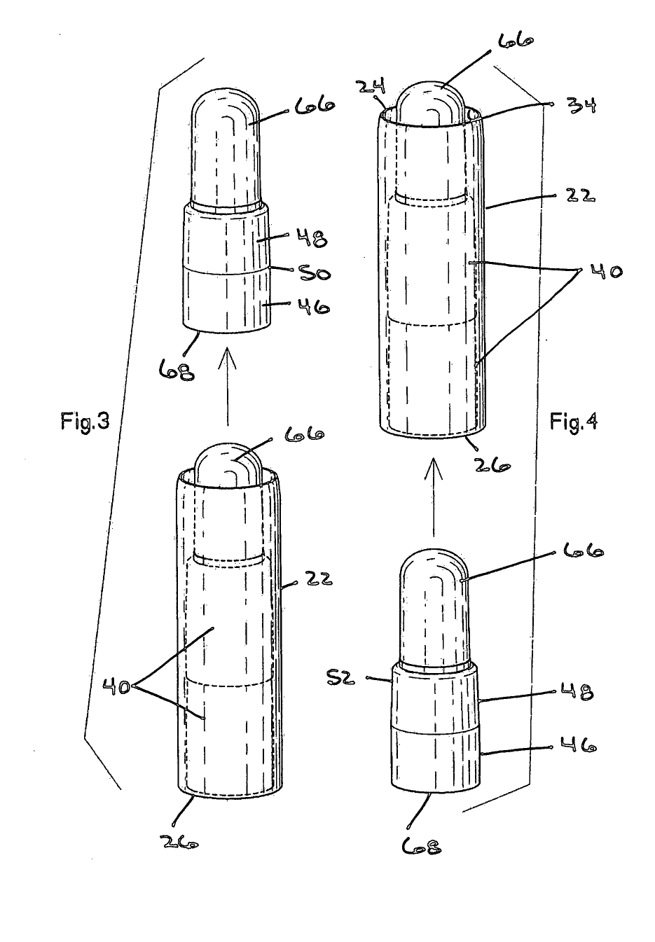

Each of candy modules 40 includes a base 42 having an outer periphery 44 that fits into, and passes through, openings 30 and 32. Generally, periphery 44 will be of the same pre-determined configuration as that of openings 30 and 32, and be of size only sufficiently smaller to permit the ready passage of base 42 up through opening 32 into opening 30 of casing 22. Base 42 has a lower section 46 and an upper section 48. As shown in the drawings, the outer periphery of base 42 is generally cylindrical, and as is perhaps best illustrated in FIG. 4, from approximately the middle 50 of base 42 there is a slight inward taper 52 of the upper section 48 towards the top to a smaller size. The somewhat smaller periphery of base 42 as it approaches the top facilitates its insertion into, and travel through, opening 30 and 32.

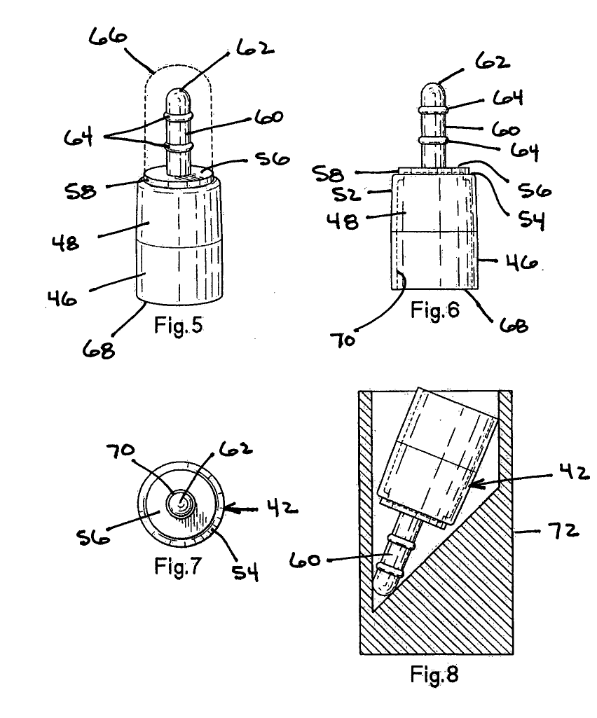

At the upper extent of taper 52 there is an inward shoulder 54, on top which is a generally flat cylindrical disc 56 having a peripheral wall 58. Extending further upwardly from disc 56 is, as illustrated in FIGS. 5-8, an elongated generally cylindrical post 60. Post is elongated along an axis, which is generally co-axial, with the axis of cylindrical base 42, and is of a considerably smaller diameter than the outer periphery of base 42. Post 60 has a top exposed end 62 that is conveniently rounded to minimize any sharp points or edges. Extending radially outwardly, transverse to the axis of post 60 are a pair of spaced apart projections 64. Base 42, including lower section 46, upper section 48, disc 56 and post 60, with its projections 64, may all be integrally molded of a suitable plastic, conveniently opaque, and as indicated previously, of different colors if desired.

The piece of candy 66 is molded or formed atop upper section 48, more particularly atop disc 56 and around post 60 to mount candy piece 66 on base 42. Post 60, particularly with its radially extending projections 64, comprises an anchoring component to more securely mount piece of candy 66 on base 42. In addition, post 60, together with upper section 48 and lower section 46 provide base 42, even after piece of candy 66 is entirely consumed, with a fixed overall size and configuration that cannot entirely fit into a standard choke gauge, such as choke tester 72 illustrated in FIG. 8, so as to avoid a choking hazard to younger children.

Lower section 46 of each base 42 of each module 40 has a bottom 68. Extending upwardly through bottom 68 of lower section 46 is a cavity 70 of a size and configuration sufficient to readily receive candy 66 nested in cavity 70. Peripheral wall 58 of disc 56 is of a size, and of course configuration, such as to readily engage cavity 70 adjacent bottom 68 of another module 40 in order to form a connected stack of candy modules 40, such as are illustrated in FIGS. 1-4.

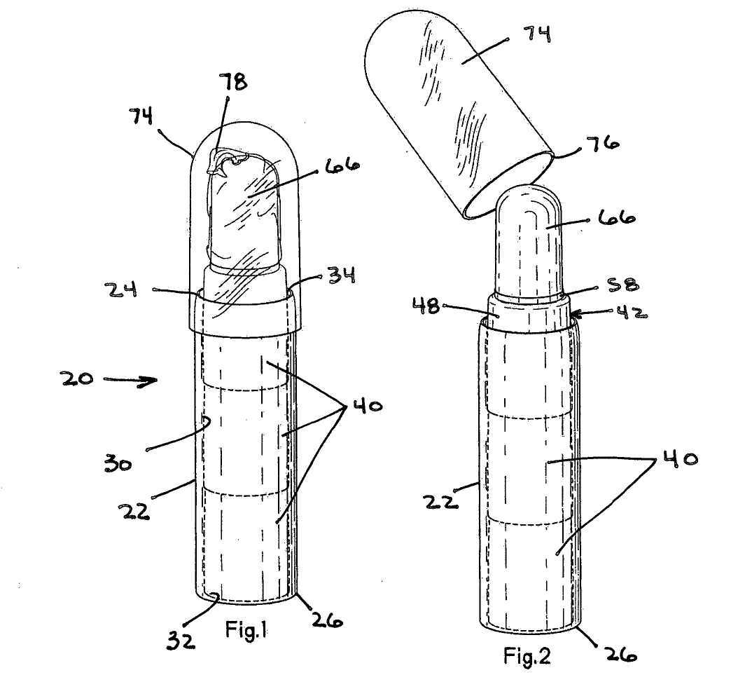

A nested, connected stack of three modules 40 is initially inserted through opening 32 in the bottom of casing 22. The length of casing 22 is shorter than the combined length of each of the three bases 42, as illustrated in FIGS. 1 and 2 so that the entirety of candy piece 66, along with a portion of upper section 48 of the base of the uppermost module is exposed above the upper end 24 of casing 22, through opening 34. As illustrated in the drawings, candy piece 66 is of a significantly smaller size than opening 34. Accordingly, as was previously indicated, the pre-selected size and configuration of opening 34 may be somewhat smaller than the pre-determined size and configuration of openings 30 and 32, and it would still permit candy piece 66 to be fully exposed for consumption.

Candy piece 66 is generally formed about post 60 by molding the candy when it is in a soft or liquid state. Once the candy cures or hardens it is securely mounted on base 42, particularly with the aid of enlarged transverse projections 64, such that candy 66 cannot be removed from post 60 without dissolving or breaking candy 66. However, when the candy piece 66 is consumed, it may be consumed in its entirety as no portion of candy piece 66 is enclosed by any portion of base 42. Thus, once cap 74 and the wrapper 78 are removed, the exposed candy piece 66 of the then uppermost candy module 40 may be consumed in its entirety.

To assist in providing a clean, sanitary product, a removable cap 74 is provided over candy 66 and minimizes contaminants coming in contact with candy 66. Cap 74 comprises a generally hemispherical dome, conveniently made of a translucent or transparent plastic, having an open bottom end 76, and is formed or molded such that it frictionally engages casing 22 adjacent its upper end 24. Those skilled in the art will recognize that cap 74 is not limited to the embodiment shown. For example, cap 74 could be of a snap-on construction or a screw-on construction, rather than simply an interference frictional engagement with casing 22. For further protection of candy 66 from contamination, each candy piece 66 of each module is covered with a flexible wrapper 78 that is conveniently formed of a foil or plastic, which may be color coordinated with the flavor of candy piece 66 and/or the color of base 42.

In operation, a child, or other user, first removes cap 74, if it is secured to casing 22, and then removes plastic wrap 78 exposing candy 66 of the uppermost module. The child may then consume the exposed candy piece 66 of the uppermost module 40 in its entirety. Alternatively, the child may elect to remove the uppermost candy module 40 and reinsert it through opening 32 in the lower end 26 of casing 22, thereby exchanging the candy modules of different flavors in any order desired. Candy 66 is generally consumed, as are most lollipops, by licking.

After candy piece 66 is consumed in its entirety by the child, the uppermost module may be readily removed through opening 34 in upper end 24 of casing 22. Removal of the module, or more particularly the remaining base 42 after candy piece 66 has been consumed, may be accomplished by either, grasping the now exposed post 60 and pulling the base 42 out in a generally axial direction, or by grasping the exposed upper section 48 and pulling base 42 out in a generally axial direction. As a further alternative, the user may insert a thumb or finger up through opening 32 in lower end 26 of casing 22, into cavity 70 of the lowermost module 40 and push up the stack of modules to completely expose the uppermost module above upper end 24 of casing 22.

Once the uppermost base 42 is removed, it will expose candy piece 66 with its protective wrapping 78 of the next candy module 40 in the connected stack. While as indicated above, the stack of modules may be advanced upwardly in casing 22 by the user pushing upwardly in cavity 70 of the lowermost module 40, upward advancement of the stack of modules is more readily accomplished by reinserting the empty base 42 back through opening 32 into cavity 70 of the then lowermost candy module 40 and pushing upwardly on the exposed lower section 46 of the empty base.

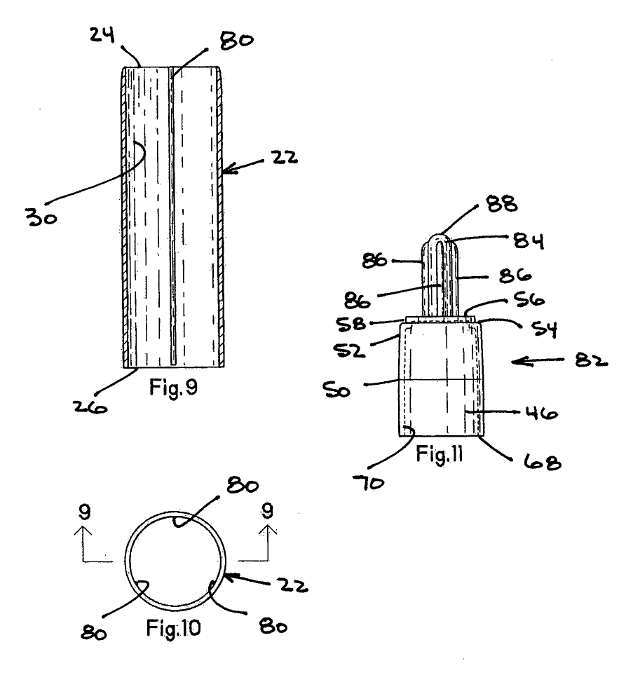

As is best illustrated in FIGS. 9 and 10 the interior opening 30 of casing 22 may be provided with a number of inwardly extending ribs 80. More particularly, there are three such ribs 80 extending substantially along the entire inner length of casing 22 from lower end 26 up to upper end 24. Ribs 80 frictionally engage outer periphery 44, particularly of the lower section 46 of each of the bases 42 in order to prevent the connected stack of modules 40 from falling out the open bottom of casing 22. By providing inwardly extending ribs 80, the amount of friction necessary to retain the stack of candy module 40 from falling out the open bottom is minimized to still permit the stack to be readily pushed upward to expose a new uppermost candy module 40.

FIG. 11 shows an alternate embodiment of a base 82 that is of similar structure with respect to that described above for lower section 46, upper section 48 taper 52, shoulder 54, disc 56 and cavity 70 of base 42. However, base 82 has a somewhat different post 84 which has a series of spaced apart, generally parallel ribs 86 extending along the length of post 84 from disc 56 up toward top 88 of the post. Ribs 86 provide a similar function to the transverse projections 64 integrally formed with post 60 to help retain the candy piece on the post.

Presently, it is understood that all businesses involved in the manufacture, distribution and retail of toys for children under three must comply with Product Safety Standards (Children's Toys) Regulations. The safety standard states toys should not be of a size that creates a hazard if swallowed or inhaled, or have small parts designed to be removed from the toy that create a hazard if swallowed or inhaled. If a toy, or a part of a toy, can fit completely into the cylinder, then it is too small and does not meet the standard. Generally, anything smaller than a 35 mm film canister will not meet the standard. FIG. 8 is a generally vertical cross-sectional view of a Choke Tester 72, also known as a Small Objects Tester, which is a standard “go/no go” safety choke-gauge designed by the Consumer Product Safety Commission to test the safety of small toys, toy parts, or other small objects. The safety standard applies to children under three years old because up to that age children do not have a coughing reflex when they choke. If they swallow or inhale an object which sticks in their throat, they do not cough and must be helped or they can choke to death. If an object fits entirely inside Choke Tester 72, then it is considered a choking hazard to a child under three years of age. This safety standard does not apply to all products. The safety standard excludes: balloons, marbles and records; books and other articles made of paper; writing materials including crayons, chalk, pencils and pens; finger paints, water color paints and other paints; modeling materials, including clay, plasticine and play-dough; flotation aid toys; bicycles having a wheelbase of not less than 640 mm; toys that are made wholly from highly porous fabric material such as cheese-cloth; playground equipment for park, school and domestic use, including swings, see-saws, slides, agility apparatus, climbing, swinging, rotating and rocking apparatus, play houses, sand pits, apparatus for use in sand, sliding poles and ladders; and goods supplied in a kitset or partially assembled state for later assembly by an adult, provided that when assembled (according to written instructions supplied with the goods) the goods comply with the standard. At this time, it is not mandatory for candy products to pass such a standard safety choke-gauge. However, in the event that it may be determined at some future time that, certain novelty candies should comply with the same standards as toys, it would be desirable that a novelty candy such as the one disclosed here did comply. As is illustrated in FIG. 8, which shows the smallest component available to the consumer, namely, base 42 one of the individual candy modules 40 after candy piece 66 has been entirely consumed, shown in FIG. 5, inserted in the Choke Tester, the product of the present invention does indeed pass the standard test.

While particular embodiments of the invention have been shown and described, further variations and modifications will occur to those skilled in the art. It is intended in the appended claims to cover all such variations and modifications as come within the true spirit and scope of the present invention.

1. A novelty confectionary device comprising in combination:
a casing having an upper end and a lower end;
an opening in the upper end;
the opening in the upper end having a pre-selected size and configuration;
an opening in the lower end;
the opening in the lower end having a pre-determined size and configuration;
the pre-selected size and configuration fitting into, and passing through the opening of the pre-determined size and configuration;
the casing having an opening of the pre-determined size and configuration extending from the opening in the lower end to the opening in the upper end;
a plurality of individually consumable candy modules carried in the casing;
each of the candy modules including a base;
the base having an outer periphery generally fitting into, and passing through the opening of the pre-determined size and configuration of the lower end, and the casing;
the base being of a fixed overall size and configuration not fitting entirely into a standard choke gauge;
the base having an upper section and a lower section;
each of the candy modules including an entirely consumable candy piece mounted on the upper section of a respective base; and
the candy piece having an outer periphery generally fitting into, and passing through the opening of the pre-selected size and configuration of the upper end.

2. The novelty confectionary device of claim 1 in which the upper section of the base includes an anchoring component for the candy piece.

3. The novelty confectionary device of claim 2 in which the anchoring component is integrally formed as part of the base.

4. The novelty confectionary device of claim 2 in which the anchoring component comprises a post.

5. The novelty confectionary device of claim 4 in which the post is elongated along an axis and has at least one transverse, external, enlarged projection.

6. The novelty confectionary device of claim 4 in which the post is elongated along an axis and has at least one axially extending, external rib along at part of the elongated post.

7. The novelty confectionary device of claim 1 including a removable cap that fits over the upper end of the casing and covers any exposed portion of a candy piece.

8. The novelty confectionary device of claim 7 in which the casing and the cap are configured for the cap to be frictionally engaged about the upper end of the casing.

9. The novelty confectionary device of claim 7 in which the cap is made of a translucent or transparent plastic.

10. The novelty confectionary device of claim 1 in which the casing is made of a translucent or transparent plastic.

11. The novelty confectionary device of claim 1 in which the upper section of the base tapers upwardly to a smaller size.

12. The novelty confectionary device of claim 1 in which:
the lower section of the base has a bottom;
a cavity extends upwardly from the bottom of the lower section of the base into the base; and
at least a portion of the candy piece of another candy module is nestable in the cavity.

13. The novelty confectionary device of claim 12 in which candy modules are nestable, and frictionally engage each other, to form a connected stack of candy modules.

14. The novelty confectionary device of claim 1 in which the casing has a length, and has at least one rib extending into the opening of the casing along at some of the length of casing.

15. The novelty confectionary device of claim 1 in which the pre-selected configuration and the pre-determined configuration are circular.

16. The novelty confectionary device of claim 1 in which the pre-selected size and configuration are the same as the pre-determined size and configuration.
